(19) United States
(12) Patent Application Publication
(10) Pub. No.: US 2007/0190404 A1
(43) Pub. Date: Aug. 16, 2007

(54) Lithium ion secondary battery

(76) Inventors: Tsuyoshi Hatanaka, Wakayama (JP); Hideaki Fujita, Osaka (JP)

Correspondence Address: MCDERMOTT WILL & EMERY LLP, 600 13TH STREET, NW, WASHINGTON, DC, 20005-3096, US

(21) Appl. No.: 11/699,580

(22) Filed: Jan. 30, 2007

(30) Foreign Application Priority Data
Jan. 30, 2006 (JP) 2006-020268

(51) Int. Cl. H01M 4/02; H01M 4/62

(52) U.S. Cl. 429/94; 429/209; 429/232

(57) ABSTRACT

A lithium ion secondary battery includes an electrode assembly configured such that positive and negative plates are wound or stacked with a separator interposed therebetween. The positive plate is configured such that positive-electrode mixture layers are formed on both surfaces of a positive-electrode current collector. The negative plate is configured such that negative-electrode mixture layers are formed on both surfaces of a negative-electrode current collector. The positive-electrode mixture layers formed on the positive plate each have a larger porosity than the negative-electrode mixture layers formed on the negative plate. A more refractory porous layer 1 than the separator is formed between the negative plate and the separator. The porous layer is made of a material for retaining an electrolyte.

### CROSS-REFERENCE TO RELATED APPLICATIONS

The disclosure of Japanese Patent Application No. 2006-020268 filed on Jan. 30, 2006 including specification, drawings and claims is incorporated herein by reference in its entirety.

### BACKGROUND OF THE INVENTION

The present invention relates to high-power lithium ion secondary batteries, and more particularly relates to high-power lithium ion secondary batteries with excellent input/output characteristics and a high level of safety.

Lithium ion secondary batteries serving as storage batteries with high energy density have been used as primary power sources for various portable devices. In particular, in recent years, it has been expected that schemes on electrode structures and current collector structures provide development oriented toward hybrid electric vehicles (HEV). Such a lithium ion secondary battery includes an electrode assembly configured such that belt-like positive and negative plates each including a current collector and mixture layers formed on the current collector are wound with a separator interposed between the positive plate and the negative plate. A several-tens-of-μm-thick microporous thin film sheet principally made of polyethylene is used for the separator. The separator electrically isolates the positive and negative plates from each other and functions to retain an electrolyte.

The electrode structure of a high-power lithium ion secondary battery is configured such that the positive and negative plates thereof each have a smaller thickness and a larger area than those of a lithium ion secondary battery for portable devices. A so-called tabless structure is used as the current collector structure of such a high-power lithium secondary battery. The tabless structure is configured as follows. Respective one ends of positive and negative plates are formed with regions at which current collectors are exposed and which are formed without mixture layers, and the exposed parts of the current collectors are welded to positive and negative current collector plates. Use of these structures can evenly ensure paths through which electrons are transferred from the belt-like electrode plates, resulting in improved output characteristics.

Since high-power lithium ion secondary batteries have attained a reduction in the thickness of each electrode plate and an increase in the area thereof as described above, this increases the risk of mixing foreign substances into the batteries as compared with lithium ion secondary batteries for portable devices. Furthermore, due to an increase in the number of turns of the electrode plate, a slight bend in the electrode plate becomes likely to cause displacements of the wound electrode plate. Therefore, it becomes significant to cope with internal short circuits.

Occurrence of an internal short circuit causes the pyrolysis reaction of a positive-electrode active material due to Joule heat generated by the short-circuit current. When this reaction produces further heat, this allows the separator to dissolve, resulting in an increase in the area in which a short circuit occurs. Thus, short circuits and heat generation are repeated, resulting in an increase in the internal temperature of the battery. Finally, the positive-electrode active material undergoes chained pyrolysis, resulting in the generation of a large amount of gas.

To cope with internal short circuits, for example, the following precautionary measure has been taken: Fabricated batteries are initially charged/discharged and then left under the environment having a temperature of 40° C., and batteries in which internal short circuits are consequently caused are previously removed from the fabricated batteries. The following other measures have also been taken: For example, current collectors of positive and negative electrodes are made thicker to improve thermal dissipation of batteries themselves; a current interrupter that prevents ignition even when a battery causes an internal short circuit is provided; and a safe structure, such as a safety valve through which a gas generated inside a battery is delivered to the outside of the battery, is provided. Furthermore, for the uses of HEVs, measures, e.g., provision of a battery control system for preventing a battery from being in an abnormal state, such as overcharge or overdischarge, or a shield plate for protecting the battery itself from physical shock, have been taken.

A method in which a short circuit inside a battery is prevented by forming a porous film made of a refractory resin, such as aramid, on a separator has been suggested in Japanese Unexamined Patent Application Publications Nos. 7-220759 and 9-208736.

In particular, when an internal short circuit inside a battery for high power application occurs in use, the short-circuit current flowing through the battery in the short circuit becomes large. The reason for this is that the battery is designed to have a low internal resistance. In view of the above, heat generated by the short-circuit current causes pyrolysis reaction of an active material, resulting in the possibility of the generation of a large amount of gas. For example, batteries for HEV application require such smoke dischargers that even under such circumstances where smoking occurs in a moving HEV, prevent a gas from flowing into a vehicle room to secure safety. This leads to an increase in the size of a battery system and a cost increase. In view of the above, for batteries for HEV application, there has been a demand for development of batteries having not only a long lifetime of ten years or more but also high output characteristics and a high level of safety.

### SUMMARY OF THE INVENTION

High output characteristics are demanded for batteries for HEV application, and therefore a positive-electrode mixture is designed to have a high porosity. However, under such design, an electrolyte inside a battery is unevenly distributed, i.e., a negative electrode contains a smaller amount of electrolyte than a positive electrode. As a result, the input characteristics of the battery become inferior to the output characteristics thereof.

Furthermore, in a case where a known precautionary measure for internal short circuits is taken in order to improve the level of safety, the internal resistances of batteries are increased, resulting in the output characteristics thereof deteriorated. As a result, attempts to provide desired output characteristics increase the battery size.

The present invention is made in view of the above problems and its main object is to provide a high-power lithium ion secondary battery with excellent input/output characteristics and a high level of safety.

A lithium ion secondary battery according to an aspect of the present invention includes an electrode assembly configured such that positive and negative plates are wound or stacked with a separator interposed between the positive and negative plates. A positive-electrode mixture layer formed on the positive plate is made of a layer having a larger porosity than a negative-electrode mixture layer formed on the negative plate, a more refractory porous layer than the separator is formed between the negative plate and the separator, and the porous layer is made of a material for retaining an electrolyte.

In this case, the positive-electrode mixture layer preferably has a porosity of 35 through 55%.

The porous layer is preferably formed on the negative-electrode mixture layer.

Furthermore, the porous layer is preferably made of a layer containing an inorganic oxide filler and preferably has a thickness of 3 through 40 μm.

With this structure, the porous layer made of the material for retaining an electrolyte is formed to a side of the negative electrode, thereby increasing the amount of the electrolyte retained to the negative electrode side. In this way, the electrolyte can be evenly distributed between the positive and negative plates. As a result, a high-power lithium ion secondary battery having balanced input/output characteristics can be achieved. Furthermore, the porous layer formed between the negative plate and the separator is more refractory than the separator. Thus, in case that an internal short circuit may occur and the separator may be dissolved by the Joule heat generated by the resultant short-circuit current, the refractory porous layer can prevent the area of a shorted part of a battery from increasing. As a result, a high-power lithium ion secondary battery with a high level of safety can be achieved.

A lithium ion secondary battery according to another aspect of the present invention includes an electrode assembly configured such that positive and negative plates are wound or stacked with a separator interposed between the positive and negative plates. A positive-electrode mixture layer formed on the positive plate is made of a material having a larger porosity than a negative-electrode mixture layer formed on the negative plate, a more refractory porous layer than the separator is formed between the positive plate and the separator, and the porous layer is made of a material for retaining an electrolyte.

In this case, the positive-electrode mixture layer preferably has a porosity of 35 through 55%.

The porous layer is preferably formed on the positive-electrode mixture layer.

With this structure, the porous layer made of the material for retaining an electrolyte is formed to a side of the positive electrode, thereby allowing the positive electrode to retain a plentiful electrolyte. In this way, a sufficiently wide SOC range can be ensured. As a result, a high-power lithium ion secondary battery with high performance can be achieved. Furthermore, the porous layer formed between the positive plate and the separator is more refractory than the separator. Thus, in case that an internal short circuit may occur and the separator may be dissolved by the Joule heat generated by the resultant short-circuit current, the refractory porous layer can prevent the area of a shorted part of a battery from increasing. As a result, a high-power lithium ion secondary battery with a high level of safety can be achieved.

### BRIEF DESCRIPTION OF THE DRAWINGS

FIG. 1A is a cross-sectional view illustrating the structure of a negative plate of a lithium ion secondary battery according to a first embodiment of the present invention, and FIG. 1B is a top view illustrating the same.

FIG. 2 is a cross-sectional view illustrating the structure of an electrode assembly of the lithium ion secondary battery according to the first embodiment of the present invention.

FIG. 3A is a graph illustrating a charge curve of a lithium ion secondary battery according to a second embodiment of the present invention, and FIG. 3B is a graph illustrating a discharge curve thereof.

FIG. 4 is a graph illustrating the SOC characteristic of the lithium ion secondary battery according to the second embodiment of the present invention.

FIG. 5 is a graph illustrating the output characteristics of lithium ion secondary batteries according to examples of the present invention.

FIG. 6 is a graph illustrating the input characteristics of the lithium ion secondary batteries according to the examples of the present invention.

FIG. 7 is a table illustrating results obtained by evaluating the characteristics of some of the lithium ion secondary batteries according to the examples of the present invention.

FIG. 8 is a table illustrating results obtained by evaluating the characteristics of lithium ion secondary batteries according to examples of the present invention.

### DETAILED DESCRIPTION OF THE INVENTION

Embodiments of the present invention will be described hereinafter with reference to the drawings. In the following drawings, components having substantially the same function are denoted by the same reference numerals for simplicity of description. The present invention is not limited to the following embodiments.

### Embodiment 1

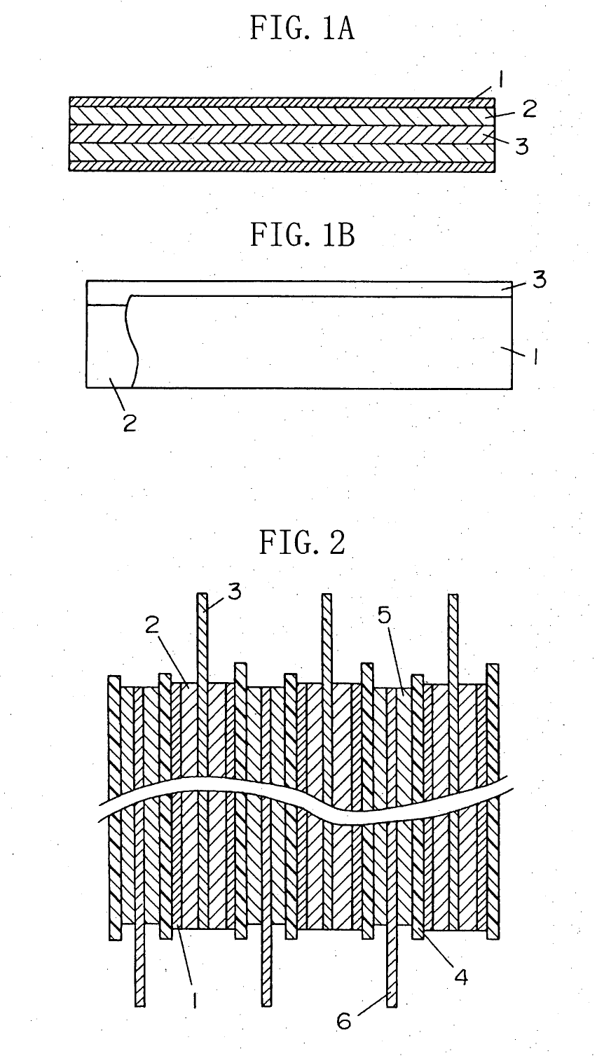

FIG. 1A is a cross-sectional view illustrating the structure of a negative plate of a lithium ion secondary battery according to a first embodiment of the present invention, and FIG. 1B is a plan view illustrating the same. FIG. 2 is a cross-sectional view illustrating the structure of an electrode assembly configured such that belt-like positive and negative plates are wound or stacked with separators interposed therebetween.

As illustrated in FIG. 2, the lithium ion secondary battery of this embodiment includes an electrode assembly configured such that positive and negative plates are wound or stacked with separators interposed therebetween. The positive plate includes a positive-electrode current collector 6 and positive-electrode mixture layers 5 formed on both sides of the positive-electrode current collector 6. The negative plate includes a negative-electrode current collector 3 and negative-electrode mixture layers 2 formed on both sides of the negative-electrode current collector 3. The positive-electrode mixture layers 5 formed on the positive plate each have a higher porosity than the negative-electrode mixture layers 2 formed on the negative plate. More refractory porous layers 1 than separators 4 are formed between the separators 4 and the negative plate and made of a material for retaining an electrolyte, which will be described below.

In this embodiment, as illustrated in FIG. 1A, porous layers 1 are formed on negative-electrode mixture layers 2. As illustrated in FIG. 1B, a negative plate of a lithium ion secondary battery has a so-called tabless structure in which one end part of the negative-electrode current collector 3 is exposed without being formed with the negative-electrode mixture layers 2 and the porous layers 1. As illustrated in FIG. 2, in order to make the area of a negative electrode larger than that of a positive electrode for controlling the battery capacity, the negative-electrode mixture layers 2 are formed so as to be opposed to all of the positive-electrode mixture layers 5.

For the lithium ion secondary battery of this embodiment, the positive-electrode mixture layers 5 each have a higher porosity than the negative-electrode mixture layers 2. This allows the positive electrode to retain a larger amount of electrolyte than the negative electrode. Therefore, lithium ions during discharge can be sufficiently supplied to the surface of a positive-electrode active material. Consequently, a lithium ion secondary battery having high output characteristics can be achieved.

In order to provide high output characteristics, the porosity of each positive-electrode mixture layer 5 preferably falls within the range of 35 to 55%. When the porosity is below 35%, the output characteristics are deteriorated. Such batteries having the deteriorated output characteristics are inappropriate as high-power batteries. Meanwhile, when the porosity is above 55%, the mixture layer itself becomes weak. This may cause leakage failures due to loss of an active material and a yield reduction in the fabrication of a positive plate. Such a porosity is not preferable in terms of reliability.

The porous layers 1 made of the material for retaining an electrolyte are formed to the sides of the negative electrode, thereby increasing the amount of the electrolyte retained to the negative electrode side. In this way, the electrolyte can be evenly distributed between the positive and negative plates. As a result, a high-power lithium ion secondary battery having balanced input/output characteristics can be achieved.

The porous layers 1 formed between the negative plate and the separators 4 that will be described below is more refractory than the separators 4. Thus, in case that an internal short circuit may occur and the separators 4 may be dissolved by the Joule heat generated by the resultant short-circuit current, the refractory porous layers 1 can prevent the area of a shorted part of a battery from increasing. As a result, a high-power lithium ion secondary battery with a high level of safety can be achieved. In addition, the thickness of each separator 4 is reduced by forming the refractory porous layers 1 on the entire surfaces of the negative-electrode mixture layers 2. This can further improve the output characteristics of the battery.

In this embodiment, each refractory porous layer 1 is formed of an inorganic oxide filler and if necessary, a small amount of binder. Alumina, titania-magnesia, or any other material can be used as a material of the inorganic oxide filler. A material that is stable under the electrical potentials of both the positive and negative electrodes, such as polyvinylidene fluoride (PVDF) or acrylic rubber, can be used as a material of the binder. The porous layer 1 can be formed in the following manner: For example, an inorganic oxide filler and a binder are dispersed using the right amount of solvent, and then the negative-electrode current collector 3 is coated with the dispersed inorganic oxide filler and binder by a comma coater or a die coater. The so formed porous layer 1 has the function of retaining an electrolyte, a very high dissolution temperature of 200° C. or more and excellent heat resistance.

For batteries for high-power application, such as HEV application, the thickness of the porous layer 1 preferably falls within the range of 3 to 40 μm. When the thickness of the porous layer 1 is below 3 μm, the effect of retaining an electrolyte cannot be sufficiently achieved. Meanwhile, when the thickness of the porous layer 1 is above 40 μm, the amount of the electrolyte retained in the porous layer 1 is increased. This causes shortage of an electrolyte in the positive electrode, resulting in uneven charge and discharge reactions. This shortens the cycle life.

From the viewpoint of improving input characteristics, the porosity of each of the negative-electrode mixture layers 2 formed on the negative current collector 3 preferably falls within the range of 35 to 50%.

In the present invention, the structures of other components than the refractory porous layers 1 are not particularly limited. However, the following structures can be applied to the other components.

The positive plate can be formed in the following manner: A positive-electrode active material made of a lithium complex oxide, such as lithium nickel oxide or lithium cobalt oxide, is kneaded with a conductive material and a binder, and the resultant material is applied, as a positive-electrode paste, to the positive-electrode current collector 6 and then dried. Carbon black, such as acetylene black (AB), a graphite material, or a metal powder that is stable under the electrical potential of the positive electrode can be used as the conductive material. A material that is stable under the electrical potential of the positive electrode, such as PVDF, modified acrylic rubber, or polytetrafluoroethylene, can be used as the binder. A cellulosic resin, such as carboxymethyl cellulose (CMC), may be used as a thickener for stabilizing the positive-electrode paste. A material that is stable under the electrical potential of the positive electrode (typically aluminum foil) can be used as the positive-electrode current collector 6.

The negative plate can be formed in the following manner: A negative-electrode active material made of graphite, silicide, a titanium alloy material, or any other material is kneaded with a binder, and the resultant material is applied, as a negative-electrode paste, to the negative-electrode current collector 3 and then dried. A material that is stable under the electrical potential of the negative electrode, such as PVDF or a styrene-butadiene rubber copolymer (SBR), can be used as the binder. A cellulosic resin, such as CMC, may be used as a thickener for stabilizing the negative electrode paste. A material that is stable under the electrical potential of the positive electrode (typically copper foil) can be used as the negative-electrode current collector 3.

The separators 4 have electrolyte retention capability, and a microporous film that is stable under the electrical potentials of both the positive and negative electrodes is generally used as a material of the separators 4. Specifically, polypropylene (PP), polyethylene (PE), polyimide, polyamide, or any other material can be used. The separators 4 of a battery for HEV are designed to each have a larger thickness than those of a battery for portable devices, thereby securing a lifetime of 10 years or more.

A battery case for containing an electrode assembly may be a metal case or a metal laminator.

### Embodiment 2

A lithium ion secondary battery is usually fully charged/discharged with its charge end voltage (SOC (state of charge)=100%) and discharge cut-off voltage (SOC=0%) set at 4.2 V and 3.0 V, respectively. On the other hand, in order to avoid an excessive voltage rise (during charge) or drop (during discharge) caused by a rapid charge/discharge, a battery for HEV is controlled in the following manner: When the voltage of the battery reaches the voltage corresponding to a SOC of 80%, charge is ended; and when the voltage of the battery reaches the voltage corresponding to a SOC of 20%, discharge is ended. In other words, the voltage of the battery is controlled to avoid falling outside the range of 3.0 to 4.2 V, thereby preventing an electrode material from being degraded.

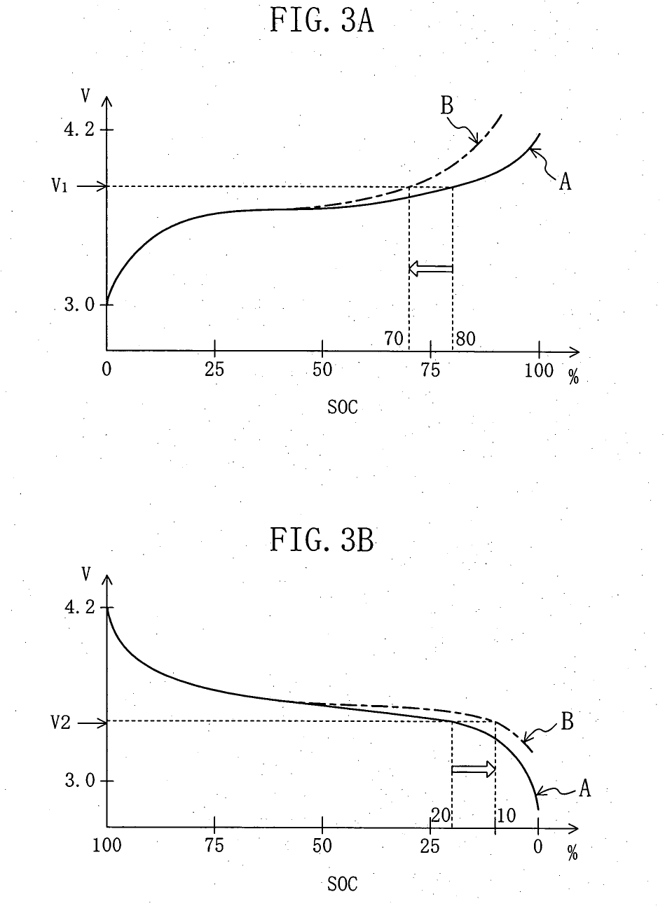

FIG. 3A is a graph illustrating a charge curve of a lithium ion secondary battery. The curve illustrated by the arrow A shows a typical charge curve, and the curve illustrated by the arrow B shows a charge curve in a case where a negative electrode contains an insufficient amount of electrolyte. On condition that the charge end voltage of a battery for HEV is V₁ (V₁<4.2 V), if the negative electrode has an insufficient amount of electrolyte, i.e., if positive-electrode mixture layers 5 each have a larger porosity than negative-electrode mixture layers 2 in order to improve output characteristics, the SOC is reduced from 80% to 70% as illustrated in FIG. 3A.

The second embodiment of the present invention is to solve such a problem. In the second embodiment, the refractory porous layers 1 of the electrode assembly illustrated in FIG. 2 are formed not on a negative electrode but on a positive electrode, i.e., between a positive plate and separators 4. The positive-electrode mixture layers 5 formed on the positive plate are made of a material having a larger porosity than that of the negative-electrode mixture layers 2 formed on the negative plate. Like the first embodiment, the porous layers 1 are made of a material for retaining an electrolyte.

FIG. 3B is a graph illustrating a discharge curve of a lithium ion secondary battery. The curve illustrated by the arrow A shows a typical discharge curve, and the curve illustrated by the arrow B shows a discharge curve in a case where the positive electrode has a plentiful electrolyte. On condition that the discharge cut-off voltage of a battery for HEV is V₂ (V₂>3.0 V), if the positive electrode has a plentiful electrolyte, the battery can be discharged until its SOC is reduced from 20% to 10% as illustrated in FIG. 3B.

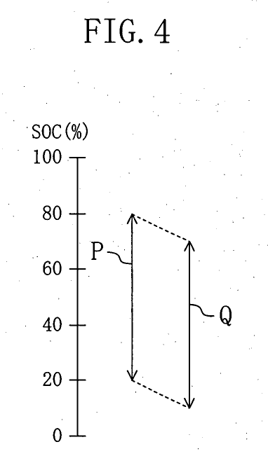

More particularly, as illustrated in FIG. 4, a typical range of the SOC (the line segment shown by the arrow P) is between 20% and 80%. On the other hand, in a case where the positive electrode has a plentiful electrolyte, i.e., in a case where the porous layers 1 are formed to the sides of the positive electrode, the range of the SOC (the line segment shown by the arrow Q) is between 10% and 70% and can have the same width as the typical range. As a result, a high-power lithium ion secondary battery exhibiting high performance can be achieved. Furthermore, the porous layers 1 formed between the positive plate and the separators 4 are more refractory than the separators 4. Thus, in case that an internal short circuit may occur and the separators 4 may be dissolved by the Joule heat generated by the resultant short-circuit current, the refractory porous layers 1 can prevent the area of a shorted part of the battery from increasing. As a result, a high-power lithium ion secondary battery with a high level of safety can be achieved.

In order to provide high output characteristics, the porosity of each positive-electrode mixture layer 5 preferably falls within the range of 35 through 55%. The porous layers 1 are preferably formed on the positive-electrode mixture layers 5.

The results of evaluating the properties of the lithium ion secondary battery of the present invention based on examples will be described hereinafter. The present invention is not limited to the following examples.

### EXAMPLE 1

A positive-electrode paste was prepared by adding 4 parts by weight of PVDF and 5 parts by weight of AB to 100 parts by weight of a complex oxide of Li, Ni, Mn, and Co and agitating the resultant mixture with the right amount of N-methyl-2-pyrrolidene (NMP). This paste was applied onto a 15-μm-thick aluminum foil (positive-electrode current collector 6) so as to be formed at one end with a 5-mm-wide exposed part, and then dried. Thereafter, a positive plate was prepared in the following manner: The combination of the paste and the aluminum foil was rolled to have a total thickness of 80 μm and cut into pieces each having a width of 53 mm (mixture layer width of 48 mm) and a length of 960 mm. The porosity of the resultant positive-electrode mixture layers 5 was 45%.

A negative-electrode paste was prepared by adding 1 part by weight (solids) of SBR and 1 part by weight (solids) of CMC to 100 parts by weight of artificial graphite and agitating the resultant mixture with the right amount of water. This paste was applied onto a 10-μm-thick copper foil (negative-electrode current collector 3) so as to be formed at one end with a 5-mm-wide exposed part, and then dried. Thereafter, a negative plate was prepared in the following manner: The combination of the paste and the aluminum foil was rolled to have a total thickness of 100 μm and cut into pieces each having a width of 55 mm (mixture layer width of 50 mm) and a length of 1020 mm. The resultant negative-electrode mixture layers 2 were adjusted to each have a porosity of 35%.

Porous layers 1 were formed continuously on the surfaces of the negative plate. The porous layers 1 were formed in the following manner. Specifically, 4 parts by weight of PVDF were added to 100 parts by weight of alumina particles having an average diameter of 0.5 μm, and the resultant mixture was agitated with the right amount of NMP. Thereafter, a paste [symbol] [symbol] [symbol] [symbol] [symbol] [symbol] by using zirconia beads each having a diameter of 0.2 mm was applied onto negative-electrode mixture layers 2, thereby forming 3-μm-thick inorganic oxide filler layers (porous layers 1).

An electrode assembly was provided by winding the positive and negative plates with a separator (a 20-μm-thick microporous film made of PP•PE) interposed therebetween.

A lithium ion secondary battery having a capacity of 1.3 Ah was prepared in the following manner. A positive-electrode current collector terminal and a negative-electrode current collector terminal were resistance-welded to the upper and lower ends of the electrode assembly, respectively. The resultant electrode assembly was inserted into a cylindrical bottomed metal case having a diameter of 18 mm and a height of 65 mm. An electrolyte was added to the metal case. Here, the electrolyte was provided by dissolving LiPF₆ at a concentration of 1 mol/l in a solvent in which EC, DEC, and DMC were mixed at a ratio of 20:40:40 (volume %). Thereafter, an opening of the metal case was sealed.

### EXAMPLES 2 THROUGH 6

Batteries were prepared in the same method as in Example 1 except that inorganic oxide filler layers of Examples 2, 3, 4, 5, and 6 had thicknesses of 10 μm, 25 μm, 40 μm, 1.5 μm, and 50 μm, respectively.

### EXAMPLE 7

A battery was prepared in the same method as in Example 1 except that a positive-electrode mixture layer had a porosity of 35% and an inorganic oxide filler layer had a thickness of 10 μm.

### EXAMPLE 8

A battery was prepared in the same method as in Example 1 except that positive-electrode mixture layers each had a porosity of 55% and inorganic oxide filler layers each had a thickness of 1.5 μm.

### COMPARATIVE EXAMPLE 1

A battery was prepared in the same method as in Example 1 except that no inorganic oxide filler layer is formed on a negative electrode.

### COMPARATIVE EXAMPLES 2 AND 3

Batteries were prepared in the same method as in Example 1 except that positive-electrode mixture layers of Comparative Examples 2 and 3 have porosities of 30% and 60%, respectively.

(Output Test)

Five batteries prepared by the method of each of Examples 1 through 8 and Comparative Examples 1 through 3 underwent an output characteristics test at a SOC of 60% and an environmental temperature of 25° C. The reason why the test was conducted at a SOC of the intermediate value is that batteries for HEV are used around a SOC of approximately 60%, depending on their control systems. The test was conducted under the following conditions: Batteries were charged to a SOC of 60%, then left under the environment at a temperature of 25° C. for ten hours or more, discharged at a constant current of 1 Iₜ [symbol] [symbol] [symbol] [symbol] [symbol] [symbol] [symbol] [symbol] [symbol] for five seconds, and subsequently experienced an unloaded condition for 30 seconds; and the resultant batteries were charged at the same current value as that at which the batteries were discharged for five seconds. Furthermore, after completion of this charge, the batteries were unloaded for 30 seconds and subsequently charged and discharged alternately as described above at current values of 2 Iₜ, 5 Iₜ, 10 Iₜ, 20 Iₜ, 30 Iₜ, and 40 Iₜ in this order. However, the lower limit voltage of each battery under discharge was set at 2.0 V, and thus the test was terminated at the point in time when the voltage fell below the set voltage during discharge. Furthermore, in some cases, although the upper limit voltage of the battery under charge was set at 4.3 V, the degree of polarization would become so large under a high load exceeding a current value of 20 Iₜ that the battery would not be able to be charged for five seconds. In such cases, on condition that the maximum charging current was set at 10 Iₜ, the battery was charged at 10 Iₜ after discharge thereof at 20 Iₜ or more while the charging time of the battery was adjusted. Thus, the battery was supplied with the same amount of electricity as the amount of discharged electricity. The voltages of the batteries at five seconds after the beginnings of discharge at the above-mentioned current values were read to determine current-voltage characteristics (I-V characteristics).

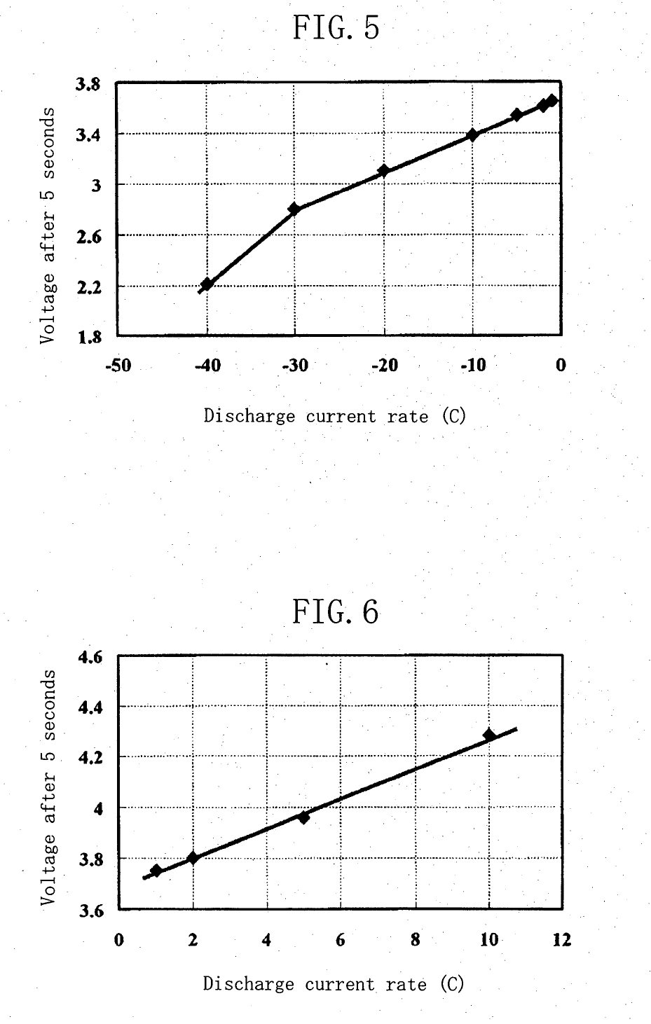

FIG. 5 is an exemplary graph of I-V characteristics. The output characteristic of each battery was determined as follows. A current value (I) corresponding to an arbitrary voltage (V) was read using this I-V characteristics graph, and the product of the current value and the voltage (V×I) was determined as the power of the battery. Referring to FIG. 5, the output voltage of the battery was measured using the voltage thereof at five seconds after the load application. The reason for this is that in consideration of the acceleration or hill climbing of a vehicle, the output characteristics at five seconds after the load application need to be determined. This period may vary according to specifications of HEVs.

(Input Test)

Batteries were charged/discharged in the same manner as in the above-mentioned output test. The voltages of the batteries at five seconds after the beginnings of charge at the above-mentioned current values were read to determine a current-voltage characteristics (I-V characteristics) graph. FIG. 6 is an exemplary I-V characteristics graph. The input characteristic of each battery was determined as follows. A current value (I) corresponding to an arbitrary voltage (V) was read using this I-V characteristics graph, and the product of the current value and the voltage (V×I) was determined as the input characteristic of the battery.

(Internal Short-Circuit Test)

Five batteries of each example were charged to 4.2 V at a current value of 260 mA and then disassembled. Thereafter, electrode assemblies were taken out of the disassembled batteries. The outermost parts of the wound electrode assemblies were spread, and metal pieces of nickel each having a width of 1 mm, a length of 5 mm and a thickness of 0.1 mm were put on positive electrodes. The spread outermost parts were again returned to their original states. Internal short-circuits were forcibly caused by externally applying pressures to the parts of the electrode assemblies into which the metal pieces were inserted. Battery behaviors in the occurrence of the internal short-circuits were observed. The disassembly of batteries and the insertion of the metal pieces into the batteries were conducted under a dry atmosphere having a dew point of −40° C. Whether or not an internal short-circuit occurred was checked based on a voltage drop observed by measuring the battery voltage.

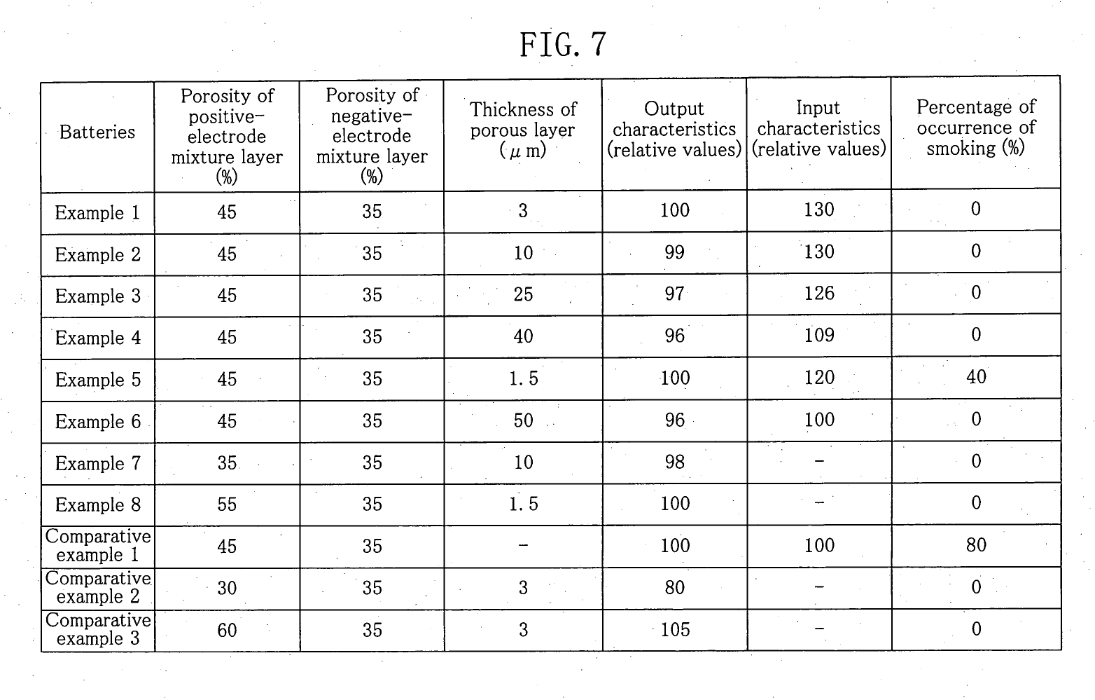

FIG. 7 is a table providing a summary of results of the above-mentioned tests.

First, for output tests, while the lower limit voltage of the battery was set at 3.0 V, the power of each battery was determined based on the above-mentioned I-V characteristics. The output characteristics in the table are represented by relative values when the power of the battery in Comparative Example 1 is 100.

As seen from this table, on condition that respective positive-electrode mixture layers of batteries have the same porosity, the output characteristic of each battery was gradually deteriorated with an increase in the thickness of an associated inorganic oxide filler layer. The reason for this is as follows. The distance between a positive electrode and a negative electrode is increased with an increase in the thickness of the inorganic oxide filler layer. As a result, the electrolyte resistance increases proportionately to the distance. However, the output characteristic only slightly decreases due to the formation of the inorganic oxide filler layer, and this power reduction can be resolved by a reduction in the thickness of a separator. Furthermore, problems generally anticipated by the reduction in the thickness of a separator, such as a reduction in the level of safety and an increase in the number of leakage failures, are resolved by the formation of an inorganic oxide filler layer.

On condition that respective inorganic oxide filler layers of batteries have the same thickness, the output characteristic of each battery varies according to the porosity of an associated positive-electrode mixture layer. It is found that in this case, the porosity of the positive-electrode mixture layer is preferably 35% or more. However, although a positive-electrode mixture layer having a porosity of 60% can be formed experimentally, the mixture layer itself becomes weak, leading to problems, such as the occurrence of leakage failures due to loss of an active material and a yield reduction in the formation of a positive plate. Therefore, the positive-electrode mixture layer having such a porosity is not preferable in terms of reliability. In view of the above, the porosity of the positive-electrode mixture layer is preferably 35 through 55%.

Next, for input tests, while the upper limit voltage of the battery was set at 4.1 V, the input characteristic of each battery was determined based on the above-mentioned I-V characteristics. The input characteristics in the table represent relative values when the input of the battery in Comparative Example 1 is 100.

As seen from this table, on condition that an inorganic oxide filler layer has a thickness of 40 μm or less, the input characteristic of an associated battery was improved as compared with a battery formed without an inorganic oxide filler layer.

The reason why a battery formed with inorganic oxide filler layers has an excellent input characteristic is considered that the inorganic oxide filler layers have an electrolyte retention capability. The charge reaction in which lithium ions are intercalated into carbon forming a negative electrode progresses. Since high-power batteries for HEV or other purposes are designed so as to be formed with positive-electrode mixture layers with high porosity, an electrolyte is nonuniformly distributed. In other words, a large amount of electrolyte is distributed to the positive electrode side while a small amount of electrolyte is distributed to the negative electrode side. However, the formation of inorganic oxide filler layers on the surfaces of the negative electrode allows the inorganic oxide filler layers to contain an electrolyte. As a result, the negative electrode can also contain a large amount of electrolyte. This facilitates supplying lithium ions to the vicinity of a negative-electrode active material in the charge reaction, resulting in improvement of the input characteristics.

Batteries with excellent input characteristics have excellent capability to recapture regenerative power. Therefore, power can be effectively utilized. It can be said that the batteries with excellent input characteristics are industrially very useful. One of the reasons for this is that such batteries for HEV are directly related to improvements in the fuel economy of cars.

Next, for internal short-circuit tests, the percentage of batteries in which smoking occurred is shown in the table. Batteries of Comparative Example 1 formed without inorganic oxide filler layers caused smoking at a high rate after the occurrence of an internal short circuit. On the other hand, batteries of Example 5 formed with 1.5-μm-thick inorganic oxide filler layers can restrain the probability of occurrence of smoking. For batteries of Examples 1 through 4 and 6 through 8 and Comparative Examples 2 and 3 formed with inorganic oxide filler layers, smoking did not occur. It is seen from the above that in cases where the thickness of each inorganic oxide filler layer exceeds 3 μm, the effect of increasing the level of safety against internal short circuits remarkably emerged.

As seen from the above, when refractory inorganic oxide filler layers are formed on the surfaces of negative electrodes, this can provide safe lithium ion secondary batteries which, even with their internal short circuits, not only restrain their explosion and ignition but also prevent smoking.

It can be said in consideration of the above-mentioned results of the input characteristics, the output characteristics, and the level of safety in the internal short circuits that an inorganic oxide filler layer preferably has a thickness of 3 through 40 μm.

Next, in order to evaluate the input characteristics of batteries according to the porosity of each of negative-electrode mixture layers, the following batteries were fabricated.

### EXAMPLES 9 THROUGH 12

Batteries of Examples 9 through 12 were fabricated in the same method as in Example 1 except that negative-electrode mixture layers of Examples 9 through 12 have porosities of 42.5%, 50%, 30%, and 55%, respectively.

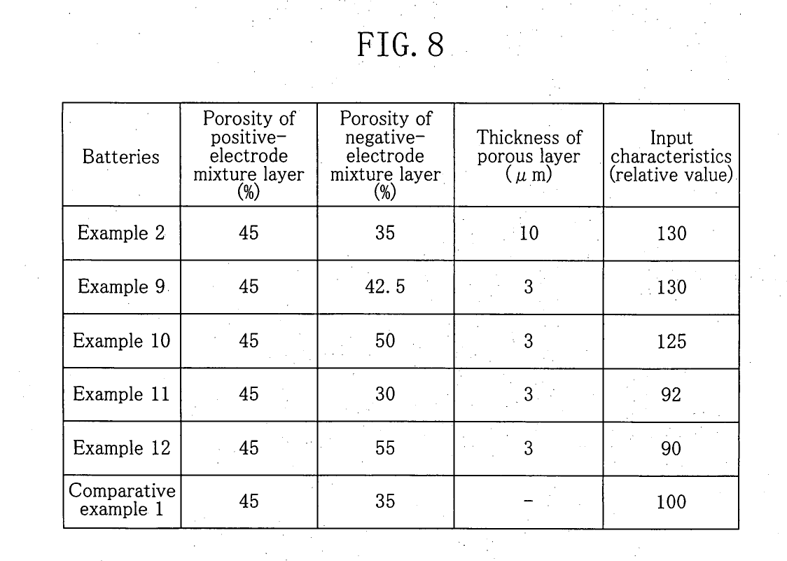

FIG. 8 is a table providing a summary of the evaluation results. The input characteristics of the batteries of Examples 2 and 9 through 12 are represented by relative values when the input characteristic of a battery of Comparative Example 1 is set at 100. It can be said from this table that the negative-electrode mixture layers preferably each have a porosity of 35 through 50%. When the porosity of each negative-electrode mixture layer exceeds 50%, this reduces the conductivity of an associated negative electrode. This conductivity reduction is considered to cause deterioration in the input characteristics. It was recognized that the level of safety of other ones of these batteries than those of Comparative Example 1 against internal short circuits had been secured by associated inorganic oxide filler layers.

Although the present invention was described above with reference to the preferred embodiments, the above description is not limited and can be certainly modified in various ways.

What is claimed is:

1. A lithium ion secondary battery comprising an electrode assembly configured such that positive and negative plates are wound or stacked with a separator interposed between the positive and negative plates,
wherein a positive-electrode mixture layer formed on the positive plate is made of a layer having a larger porosity than a negative-electrode mixture layer formed on the negative plate,
a more refractory porous layer than the separator is formed between the negative plate and the separator, and
the porous layer is made of a material for retaining an electrolyte.

2. The lithium ion secondary battery of claim 1, wherein
the positive-electrode mixture layer has a porosity of 35 through 55%.

3. The lithium ion secondary battery of claim 1, wherein
the porous layer is formed on the negative-electrode mixture layer.

4. The lithium ion secondary battery of claim 1, wherein
the porous layer is made of a layer containing an inorganic oxide filler.

5. The lithium ion secondary battery of claim 1, wherein
the porous layer has a thickness of 3 through 40 μm.

6. A lithium ion secondary battery comprising an electrode assembly configured such that positive and negative plates are wound or stacked with a separator interposed between the positive and negative plates,
wherein a positive-electrode mixture layer formed on the positive plate is made of a material having a larger porosity than a negative-electrode mixture layer formed on the negative plate,
a more refractory porous layer than the separator is formed between the positive plate and the separator, and
the porous layer is made of a material for retaining an electrolyte.

7. The lithium ion secondary battery of claim 6, wherein
the positive-electrode mixture layer has a porosity of 35 through 55%.

8. The lithium ion secondary battery of claim 6, wherein
the porous layer is formed on the positive-electrode mixture layer.
